(19) United States
(12) Patent Application Publication
(10) Pub. No.: US 2010/0006078 A1
(43) Pub. Date: Jan. 14, 2010

(54) ENGINE CONTROLLER

(75) Inventor: Hirofumi SHODA, Toyota-shi (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/476,527

(22) Filed: Jun. 2, 2009

(30) Foreign Application Priority Data
Jul. 11, 2008 (JP) 2008-181105

(51) Int. Cl. F02D 41/00; F01N 9/00; F01N 3/10

(52) U.S. Cl. 123/676; 60/285; 60/299

(57) ABSTRACT

An engine controller is applied to a system that includes an engine and an exhaust purifying catalyst for purifying exhaust gas of the engine. The engine controller has an idle stopping means, a catalyst temperature detecting means and an engine restarting means. The idle stopping means stops the engine when a predetermined idle stop condition is satisfied. The catalyst temperature detecting means detects a temperature of the exhaust purifying catalyst while the engine is stopped by the idle stopping means. The engine restarting means restarts the engine when the temperature of the exhaust purifying catalyst, which is detected by the catalyst temperature detecting means, becomes equal to or lower than an engine restart determination temperature, which is determined on a basis of an activation temperature of the exhaust purifying catalyst.

### CROSS REFERENCE TO RELATED APPLICATION

This application is based on and incorporates herein by reference Japanese Patent Application No. 2008-181105 filed on Jul. 11, 2008.

### BACKGROUND OF THE INVENTION

1. Field of the Invention

The present invention relates to an engine controller having an idle stop function.

2. Description of Related Art

Conventionally, an engine control system having an idle stop function is known. The idle stop function automatically stops and restarts an engine of a vehicle by detecting movement of the vehicle such as stops and starts. Specifically, ON/OFF switching of an accelerator, ON/OFF switching of a brake, vehicle speed, etc. are specified as parameters of conditions for stopping and restarting the engine. Moreover, an engine control system uses a performance of an exhaust purifying catalyst as a parameter of the conditions for stopping and restarting engine (see JP2002-276408A, for example), The engine control system disclosed in JP2002-276408A predicts whether a temperature of an exhaust purifying catalyst will rise if an engine is stopped, on a basis of a temperature of exhaust gas and a temperature of the exhaust purifying catalyst. Then, the engine control system controls running and stopping of the engine. That is, the engine control system disables stopping of the engine when it determines that the performance of the exhaust purifying catalyst is lowered. Thereby, it is possible to inhibit unburned constituent of fuel from being emitted as exhaust gas.

However, the engine control system according to JP2002-276408A does not take it into account that the temperature of the exhaust purifying catalyst falls while the engine is not running. That is, even if the temperature of the exhaust purifying catalyst is higher than a catalyst activation temperature when the engine is stopped, combustion of the engine keeps stopping thereafter. Therefore, the temperature of the exhaust purifying catalyst can fall below the catalyst activation temperature while the engine is not running. If the combustion of the engine is started again by a restart of the engine, which follows the stop of the engine, there is an apprehension that HC, CO, NOx, etc. contained in the exhaust gas are emitted to the atmosphere as they are without being sufficiently purified.

### SUMMARY OF THE INVENTION

The present invention is made in view of the above-mentioned problem. Thus, it is an objective of the present invention to provide an engine controller that has an idle stop function and can reduce emission at a restart of an engine.

To achieve the objective of the present invention, there is provided an engine controller that is applied to a system that includes an engine and an exhaust purifying catalyst for purifying exhaust gas of the engine. The engine controller has an idle stopping means, a catalyst temperature detecting means and an engine restarting means. The idle stopping means stops the engine when a predetermined idle stop condition is satisfied. The catalyst temperature detecting means detects a temperature of the exhaust purifying catalyst while the engine is stopped by the idle stopping means. The engine restarting means restarts the engine when the temperature of the exhaust purifying catalyst, which is detected by the catalyst temperature detecting means, becomes equal to or lower than an engine restart determination temperature, which is determined on a basis of an activation temperature of the exhaust purifying catalyst.

### BRIEF DESCRIPTION OF THE DRAWINGS

The invention, together with additional objectives, features and advantages thereof, will be best understood from the following description, the appended claims and the accompanying drawings in which:

FIG. 1 is a schematic diagram showing a configuration of an engine control system that includes an engine controller according to an embodiment of the present invention;

FIG. 2 is a flowchart showing an example of a process for restarting an engine; and

FIG. 3 is a timing chart showing temperature of a catalyst while the engine is stopped and after the engine is restarted.

### DETAILED DESCRIPTION OF PREFERRED EMBODIMENTS

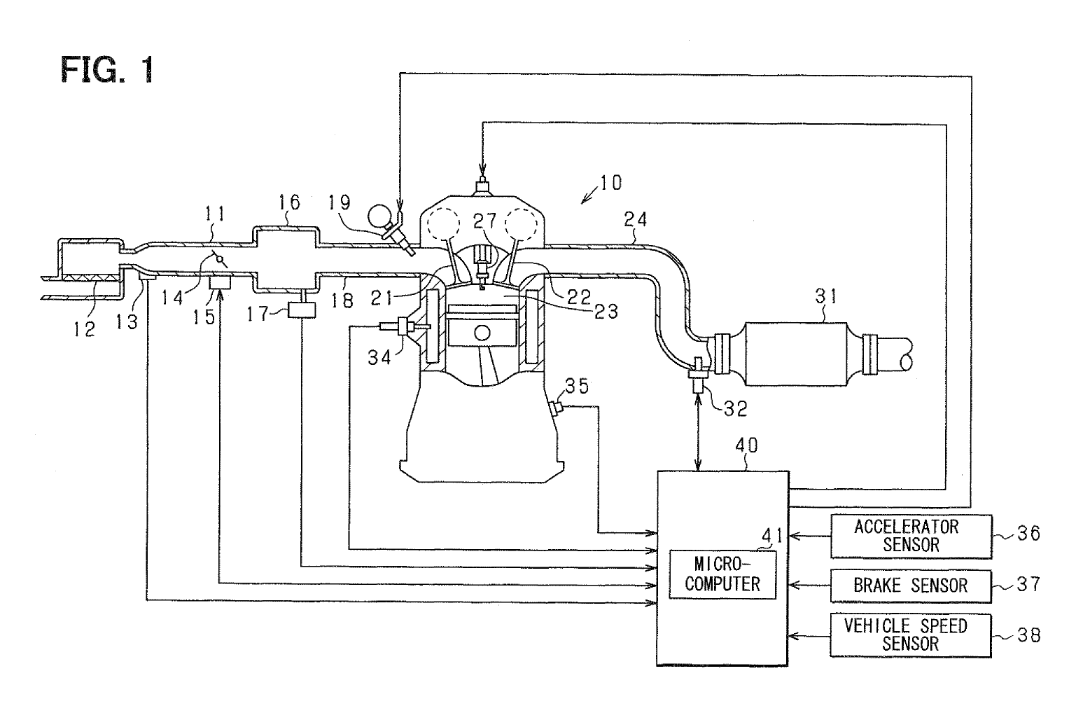

An embodiment of the present invention will be described hereafter with reference to accompanying drawings. In this embodiment, an engine control system is configured to control an in-vehicle multi-cylinder gasoline engine. In the engine control system, an electric control unit (hereafter referred to as ECU) plays a central role in controlling fuel injection quantity, ignition timings, idle stops, etc. FIG. 1 schematically shows a configuration of the engine control system.

In an engine 10 shown in FIG. 1, an air cleaner 12 is located at the most upstream side of an intake pipe 11 (intake passage). An air flow meter 13, which is for detecting intake air flow rate, is located on a downstream side of the air cleaner 12. A throttle valve 14 is located on a downstream side of the air flow meter 13. An opening degree of the throttle valve 14 is adjusted by a throttle actuator 15 such as a DC motor. The opening degree of the throttle valve 14 (throttle opening degree) is detected by a throttle position sensor that is incorporated in the throttle actuator 15. A surge tank 16 is located on a downstream side of the throttle valve 14. An intake air pressure sensor 17 for detecting intake pipe pressure is attached to the surge tank 16. An intake manifold 18, which is for introducing air into each cylinder of the engine 10, is connected to the surge tank 16. Electromagnetically-driven fuel injection valves 19 are located in the intake manifold 18 in the vicinity of intake ports of corresponding cylinders.

An intake valve 21 and an exhaust valve 22 are located at an intake port and an exhaust port of the engine 10, respectively. An open of the intake valve 21 introduces air-fuel mixture into a combustion chamber 23, and an open of the exhaust valve 22 discharges exhaust gas generated by combustion to an exhaust pipe 24 (exhaust passage).

Spark plugs 27 are installed on a cylinder head of the engine 10 to correspond to respective cylinders. High voltage is applied to the spark plug 27 at desired ignition timings by an ignition device (not shown) that includes an ignition coil. By applying high voltage, spark discharge is generated between opposing electrodes of each spark plug 27, and the air-fuel mixture introduced into the combustion chamber 23 is ignited and combusted.

A catalyst 31 such as a three-way catalyst, which is for purifying CO, HC, NOx, etc. in the exhaust gas, is installed in the exhaust pipe 24. An A/F sensor 32, which is for detecting air-fuel ratio (oxygen concentration) of the exhaust gas, is located on an upstream side of the catalyst 31.

A coolant temperature sensor 33 and a crank angle sensor 35 are attached to the engine 10. The coolant temperature sensor 33 is for detecting coolant temperature. The crank angle sensor 35 outputs a rectangular-shaped crank angle signals at intervals of a predetermined crank angle of the engine 10 (in a cycle of 30° CA, for example). In addition, the engine control system is provided with an accelerator sensor 36 for detecting an accelerator opening degree, an atmospheric pressure sensor 37 for detecting atmospheric pressure, a vehicle speed sensor 38 for detecting vehicle speed, etc.

The ECU 40 has a microcomputer 41 as a main component. The microcomputer 41 includes a CPU, a ROM, a RAM, etc. The ECU 40 executes various kinds of control programs stored in the ROM. Thereby, the ECU 40 performs various controls of the engine 10 in accordance with occasional running states of the engine 10. Specifically, various detection signals are inputted to the microcomputer 41 of the ECU 40 from the above-mentioned various kinds of the sensors, etc. Then, the microcomputer 41 calculates fuel injection quantity, ignition timings, etc. to controls operations of the fuel injection valve 19 and the ignition device, and performs idle stop controls on a basis of these various detection signals.

As the idle stop control, the microcomputer 41 stops fuel injections and ignitions in order to stop the engine 10 automatically when a predetermined idle stop condition is satisfied. Moreover, when a predetermined engine restart condition is satisfied while the engine 10 is stopped, the microcomputer 10 provides the engine 10 with initial rotation by cranking and then resumes fuel injections and ignitions in order to restart the engine 10 automatically. A switching off of an accelerator, a switching on of a brake, zero vehicle speed, etc. are supposed as the predetermined idle stop condition. A switching off of the brake, etc. are supposed as the predetermined engine restart condition.

The catalyst 31 has a characteristic that a catalytic performance changes in accordance with temperature. When the temperature is equal to a catalyst activation temperature (350° C., for example) or higher, catalytic reaction is promoted and the catalyst 35 fully exhibits exhaust purification function. When the engine 10 is automatically stopped by the idle stop control, fuel injections and ignitions are stopped. Therefore, the temperature of the catalyst 31 can fall. In this case, if the temperature of the catalyst 31 falls below the catalyst activation temperature, HC, CO, NOx, etc. in the exhaust gas cannot be sufficiently purified by the catalyst 31 soon after fuel injections and ignitions are resumed by a restart of the engine 10. Therefore, HC, CO, NOx, etc. in the exhaust gas can be emitted to the atmosphere as they are. Generally, fuel injection quantity is corrected to increase especially at the time of engine start. Therefore, in order to make full use of the catalytic performance of the catalyst 31 at the time of engine start, it is necessary to maintain the temperature of the catalyst 31 above the catalyst activation temperature.

In this regard, the engine restart condition includes a condition of the temperature of the catalyst 13 in this embodiment. That is, the engine 10 is automatically restarted when the temperature of the catalyst 31 has fallen below an engine restart determination temperature while the engine 10 is automatic stopped by the idle stop control. The engine restart determination temperature is determined on a basis of the catalyst activation temperature. Thereby, emission of HC etc. in the exhaust gas is restrained when the engine 10 is automatically restarted. In order to implement the above-mentioned controls, the microcomputer 41 of the ECU 40 performs the following process.

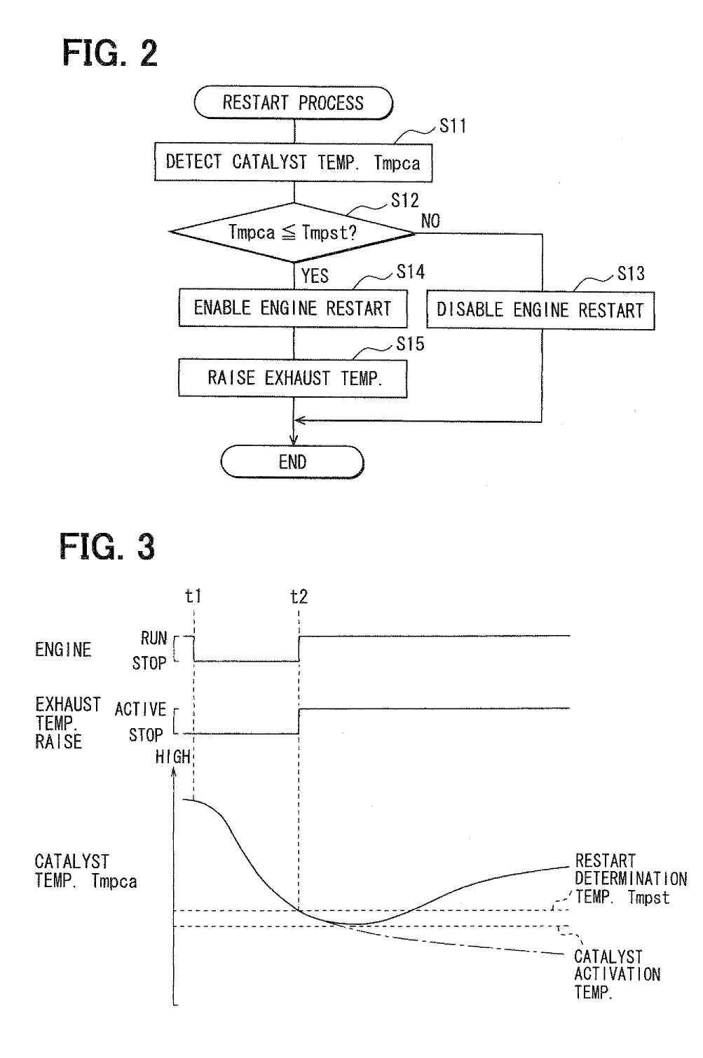

FIG. 2 is a flowchart showing an example of the process for automatically restarting the engine 10 while the engine 10 is stopped by the idle stop control. This process is performed at intervals of a predetermined time by the microcomputer 41 of the ECU 40 since the condition for stopping the engine 10 is satisfied (since it is commanded to stop fuel injections and ignitions) until the restart of the engine 10 is completed (until a rotational speed of the engine becomes equal to a predetermined speed or greater, for example).

In FIG. 2, firstly at step S11, the temperature Tmpca of the catalyst 31 is detected while the engine 10 is stopped by the idle stop control. In this embodiment, the temperature of the catalyst 31 is estimated on a basis of a temperature of coolant of the engine 10, which is detected by a coolant temperature sensor 34, and a time for which the engine 10 is stopped by the idle stop control. Then, the estimated temperature is regarded as the temperature Tmpca of the catalyst 31. In this case, the temperature Tmpca of the catalyst 31 may be estimated in view of an ambient temperature. If the catalyst 31 is provided with a catalyst temperature sensor for detecting the temperature Tmpca of the catalyst 31, the detection value of the catalyst temperature sensor may be regarded as the temperature Tmpca of the catalyst 31.

At step S12, it is determined whether the detected temperature Tmpca of the catalyst 31 is equal to or lower than an engine restart determination temperature Tmpst. In this embodiment, the engine restart determination temperature Tmpst is set on a basis of the catalyst activation temperature of the catalyst 31. Specifically, the engine restart determination temperature Tmpst is set to a value that is higher than the catalyst activation temperature of the catalyst 31 by a predetermined temperature difference (10° C., for example).

If the temperature Tmpca of the catalyst 31 is higher than the engine restart determination temperature Tmpst, the process goes to step S13, in which the restart of the engine 10 is disabled to keep the engine 10 stopped. In contrast, if the temperature Tmpca of the catalyst 31 is equal to or lower than the engine restart determination temperature Tmpst, the process goes to step S14, in which the restart of the engine 10 is enabled. Thereby, cranking of the engine 10 is started, and fuel injections and ignitions are resumed.

Then, at step S15, an exhaust temperature raising process, which is a process for raising exhaust temperature, is performed. In this embodiment, the exhaust temperature raising process delays ignition timings of an ignition device. Thereby, the exhaust temperature is raised, and the temperature Tmpca of the catalyst 31 is raised by the heat of the exhaust gas.

Here, the exhaust temperature raising process is not limited to delaying the ignition timings provided the exhaust temperature raising process can raise the exhaust temperature. In addition to the process of delaying the ignition timings, the exhaust temperature can be raised also by performing a lean-burn control. Specifically, as the lean-burn control, the fuel injection quantity is controlled so that a target air-fuel ratio is set to a lean value. As the exhaust temperature raising process, it is also possible to increase air intake quantity and fuel injection quantity to raise idle speed of the engine 10. Specifically, a throttle actuator 15 increases a throttle opening degree to increase the air intake quantity. Then, fuel injection quantity, which corresponds to the air intake quantity, is injected. These exhaust temperature raising processes may be performed simultaneously or alternately.

FIG. 3 is a timing chart showing the temperature Tmpca of the catalyst 31 while engine 10 is stopped by the idle stop control and after the engine 10 is restarted. In FIG. 3, which shows a change of the temperature Tmpca of the catalyst 31, a solid line indicates a case in which the temperature Tmpca of the catalyst 31 is one of parameters of the engine restart condition. A chain line indicates a case in which the temperature Tmpca of the catalyst 31 is not included in the parameters of the engine restart condition.

In FIG. 3, the idle stop condition is satisfied at time t1, and fuel injections and ignitions are stopped in order to stop the engine 10 automatically. While the engine 10 is stopped by the idle stop control, the temperature Tmpca of the catalyst 31 becomes equal to or lower than the engine restart determination temperature Tmpst at time t2, and the engine 10 is forcibly restarted. Thereby, the temperature Tmpca of the catalyst 31 is raised by the heat of the exhaust gas emitted from the engine 10, and the temperature Tmpca of the catalyst 31 is maintained above the catalyst activation temperature. When the engine 10 is restarted, the exhaust temperature raising process delays the ignition timings so as to promote the rise of the temperature Tmpca of the catalyst 31.

The following advantages can be obtained from the above-described embodiment.

After the engine 10 is automatically stopped by the idle stop control, the engine 10 is automatically restarted when the temperature Tmpca of the catalyst 31 becomes equal to or lower than the engine restart determination temperature Tmpst while the engine 10 is stopped. Thereby, it is possible to inhibit the temperature Tmpca of the catalyst 31 from excessively falling. Thereby, the catalyst 31 can sufficiently exhibit catalytic performance, and emission can be reduced when the engine 10 is restarted.

The exhaust temperature raising process is performed when the engine 10 is restarted. Thereby, the temperature Tmpca of the catalyst 31 is securely kept above the catalyst activation temperature. Moreover, the exhaust temperature is raised by delaying ignition timings. Therefore, the exhaust temperature can be easily raised.

The engine restart determination temperature Tmpst is set to a value that is higher than the catalyst activation temperature of the catalyst 31. Thereby, it is possible to securely inhibit the temperature Tmpca of the catalyst 31 from failing below the catalyst activation temperature while the engine 10 is automatically stopped by the idle stop control.

### Other Embodiments

The present invention is not limited only to the above-described embodiment, but may be put into practice as follows, for example.

In the above-described embodiment, it is possible to include the temperature of the catalyst 31 as one of parameters of the idle stop condition. That is, the idle stop condition may further include a condition that the temperature of the catalyst 31 is equal to or higher than a predetermined idle stop determination temperature, which is set on a basis of the catalyst activation temperature. When the temperature of the catalyst 31 becomes equal to or higher than the predetermined idle stop determination temperature, the engine 10 is automatically stopped. By this construction, even if the temperature of the catalyst 31 is equal to or higher than the catalyst activation temperature when the engine 10 is automatically stopped, the engine 10 is automatically restarted when the temperature of the catalyst 31 has fallen below the engine restart determination temperature while the engine 10 is stopped. Therefore, it is possible to appropriately reduce emission even if the temperature of the catalyst 31 falls while the engine is automatically stopped by the idle stop control. The value of the idle stop determination temperature may be equal to the engine restart determination temperature Tmpst. The value of the idle stop determination temperature may be different from the engine restart determination temperature.

In the above-described embodiment, the engine restart determination temperature Tmpst may be raised when it is impossible to perform the exhaust temperature raising process. For example, when the ignition timings are delayed on a condition that the ambient temperature or the coolant temperature is extremely low (below freezing, for example), the engine 10 may be unable to start. Therefore, if the ambient temperature is equal to or lower than a predetermined quite low temperature when the engine 10 is stopped or while the engine 10 is stopped, the engine restart determination temperature Tmpst is raised than when the ambient temperature or the coolant temperature is higher than the predetermined quite low temperature (than when the exhaust temperature raising process is performed), instead of performing the exhaust temperature raising process. Thereby, the engine 10 is restarted when the catalyst 31 is at a higher temperature. Accordingly, when it is impossible to perform the exhaust temperature raising process, it is possible to effectively inhibit HC etc. in the exhaust gas from being emitted to atmosphere due to a temperature decrease of the catalyst 31.

In the above-described embodiment, the engine restart determination temperature Tmpst is set to a value that is higher than the catalyst activation temperature. Alternatively, the engine restart determination temperature may be set to a value that is approximately equal to the catalyst activation temperature. It is also possible to set the engine restart determination temperature to a value that is lower than the catalyst activation temperature. In these cases, it is possible to keep the engine 10 stopped for a longer time than a case in which the engine restart determination temperature Tmpst is set to a value that is higher than the catalyst activation temperature. Especially when the exhaust temperature raising process is performed when the engine 10 is restarted, the temperature of the exhaust gas is raised by the exhaust temperature raising process by about 10° C. to 100° C., for example. Therefore, even when the engine restart determination temperature Tmpst is set to a value that is lower than the catalyst activation temperature, it is possible to raise the temperature of the catalyst 31 above the catalyst activation temperature by performing the exhaust temperature raising process. Accordingly, it is possible to secure catalytic function promptly when the engine 10 is restarted, in keeping the engine 10 stopped as long as possible within a period since the engine 10 is stopped by the idle stop control until the engine 10 is restarted in accordance with a command by a driver.

In the above-described embodiment, in a case where the temperature Tmpca of the catalyst 31 becomes equal to or lower than the engine restart determination temperature Tmpst and the exhaust temperature raising process is started, it is also possible to stop performing the exhaust temperature raising process when a predetermined time is elapsed since the exhaust temperature raising process is started. In a case where the temperature Tmpca of the catalyst 31 remains equal to or higher than the catalyst activation temperature for a certain time since the exhaust temperature raising process is started, it is also possible to stop performing the exhaust temperature raising process when a predetermined time is elapsed since the temperature Tmpca of the catalyst 31 becomes equal to or higher than the catalyst activation temperature.

In the above-described embodiment, the engine control system is applied to a gasoline engine. Alternatively, the engine controller according to the present invention may be applied to a diesel engine.

Additional advantages and modifications will readily occur to those skilled in the art. The invention in its broader terms is therefore not limited to the specific details representative apparatus, and illustrative examples shown and described.

What is claimed is:

1. An engine controller for controlling a system that includes an engine and an exhaust purifying catalyst for purifying exhaust gas of the engine, comprising:
an idle stopping means for stopping the engine when a predetermined idle stop condition is satisfied;
a catalyst temperature detecting means for detecting a temperature of the exhaust purifying catalyst while the engine is stopped by the idle stopping means; and
an engine restarting means for restarting the engine when the temperature of the exhaust purifying catalyst, which is detected by the catalyst temperature detecting means, becomes equal to or lower than an engine restart determination temperature, which is determined on a basis of an activation temperature of the exhaust purifying catalyst.

2. The engine controller according to claim 1, wherein
the engine is stopped by the idle stopping means on a condition that the temperature of the exhaust purifying catalyst becomes equal to or higher than a predetermined idle stop determination temperature, which is determined on a basis of the activation temperature of the exhaust purifying catalyst.

3. The engine controller according to claim 1, wherein
the engine restarting means performs an exhaust temperature raising process for raising a temperature of the exhaust gas of the engine when the engine restarting means restarts the engine.

4. The engine controller according to claim 3, wherein the exhaust temperature raising process performed by the engine restarting means includes at least one of:
delaying ignition timings of the engine;
raising an idle speed of the engine; and
performing a lean-burn of the engine.

5. The engine controller according to claim 3, further comprising
a prohibiting condition detecting means for detecting that a prohibiting condition for prohibiting the exhaust temperature raising process is satisfied, wherein
the engine restart determination temperature is raised when the prohibiting condition detecting means detects that the prohibiting condition is satisfied.
